(19) United States
(12) Patent Application Publication
(10) Pub. No.: US 2011/0187322 A1
(43) Pub. Date: Aug. 4, 2011

(54) Battery Charger With Code Reader

(76) Inventor: Mathew Inskeep, Boca Raton, FL (US)

(21) Appl. No.: 12/912,802

(22) Filed: Jan. 5, 2011

Related U.S. Application Data
(60) Provisional application No. 61/255,441, filed on Oct. 27, 2009.

(51) Int. Cl. H02J 7/04; H02J 7/00

(52) U.S. Cl. 320/109; 320/107

(57) ABSTRACT

A multi-purpose battery charger and reconditioner with diagnostic code reader. The device is portable and includes electronic circuitry for use is desulfating and charging lead acid batteries in automobiles. An internal diagnostic code reader displays automobile fault codes received from the automobile's on board computer system. The charger, code reader, connecting cables are all integrated into a light weight compact housing.

### CROSS REFERENCE TO RELATED APPLICATIONS

This application claims the benefit under 35 U.S.C. 119(e) of the Provisional Patent Application No. 61/255,441 entitled “BATTERY CHARGER WITH CODE READER” the entirety of which is incorporated herein by reference. This is also a response to the Notice of Incomplete Nonprovisional Application Ser. No. 12/912,802.

### FIELD OF THE INVENTION

This invention relates generally battery chargers and code reader providing an integrated diagnostic tool along with the battery charger.

### BACKGROUND OF THE INVENTION

Battery chargers and code readers have existed independently for many years. Many consumers have experienced a ‘dead’ battery that typically results when the lights are left on or some other load is left to draw power from the car battery without the motor turning the alternator. Additionally lack of operation of a vehicle may lead to a dead battery. Battery chargers help maintain and condition automobile batteries to prevent dead batteries.

Code readers have been available to consumers so that they may diagnose problems with their vehicle. This enables the consumer to fix the vehicle himself/herself or simply be better informed and educated when bringing the vehicle to a mechanic for repair. Today's modern on board automobile computers interfacing with a fault code reader provide accurate information as to problems with a vehicle.

This invention combines the functions of a battery charger coupled with the diagnostic code reader. A code reader can be used to diagnose operational faults in automobile's data acquisition systems and dynamometers, so you can maximize your vehicle's performance and safety. Diagnostic systems monitor everything from cylinder misfires to improperly closed gas caps.

This invention is a method of displaying automotive diagnostic information comprising: connecting a code reader to a vehicle computer; communicating monitor status information and troublecodes to the code reader from the on board vehicle computer.

### SUMMARY OF THE INVENTION

The present invention is a battery charger combined with a code reader. The invention combines the functionality of a high frequency battery charger and diagnostic code reader giving the user a product that can charge a 6/12 volt battery, battery voltage meter, battery desulphate, quick start vehicle timer and code reader. This single device combines multiple automotive tools in one compact place.

An objective of the invention is to provide a multifunction apparatus that provides a battery charger, and code reader to combine charging capabilities and diagnostic tools in a single easy to use unit. The battery and code reader are housed within a single structure sharing the same components-LCD screen, power cord, housing, central processing unit and digital diagnostic cable.

Objective and advantages of this invention to provide a reliable and less expensive device that combines automotive diagnostic and battery charger capabilities in one portable unit. This invention is a ‘one stop’ integrated device that empowers the consumer to maintain and repair an automobile in a single product.

While there are code readers that exist independently as a device unto themselves as disclosed in other patents (see below) and there are battery chargers that also exist independently as a device unto themselves as disclosed below, the battery charger with code reader device described herein for the first time combines the advantages of both features.

Other objectives and advantages of this invention will become apparent from the description taken in conjunction with the accompanying drawings wherein are set forth by way of illustration and example . The drawings constitute a part of this specification and include exemplary embodiments of the present invention and illustrate various objects and features thereof.

### BRIEF DESCRIPTION OF THE DRAWINGS

FIG. 1 is a block diagram of the battery charger with code reader electrical interconnects.

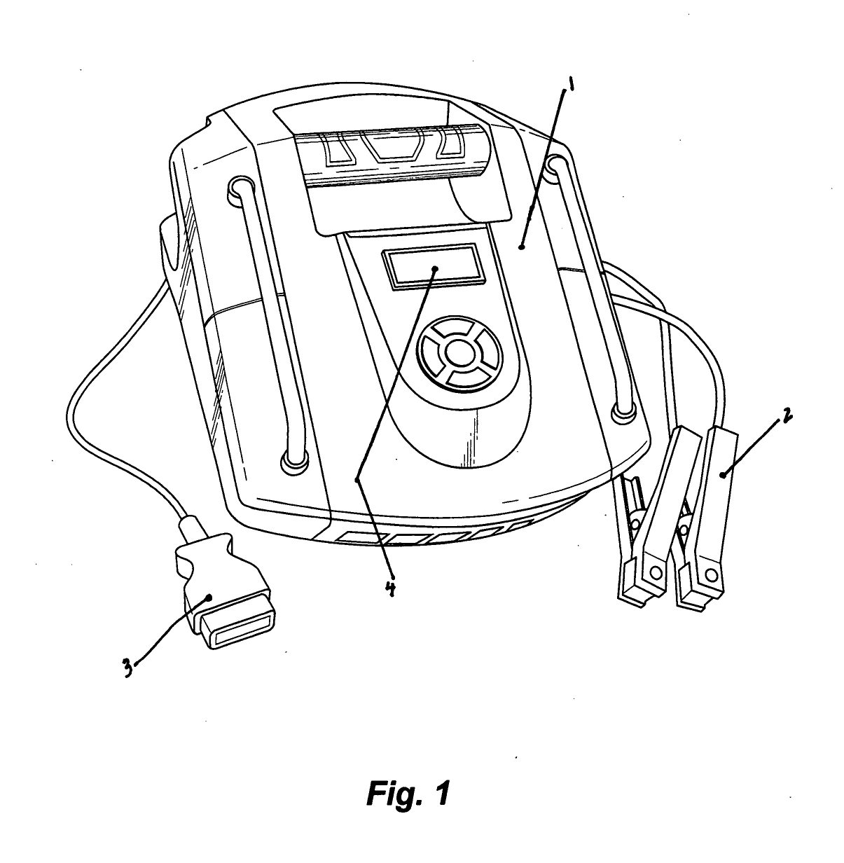

FIG. 2 is a view of the present invention

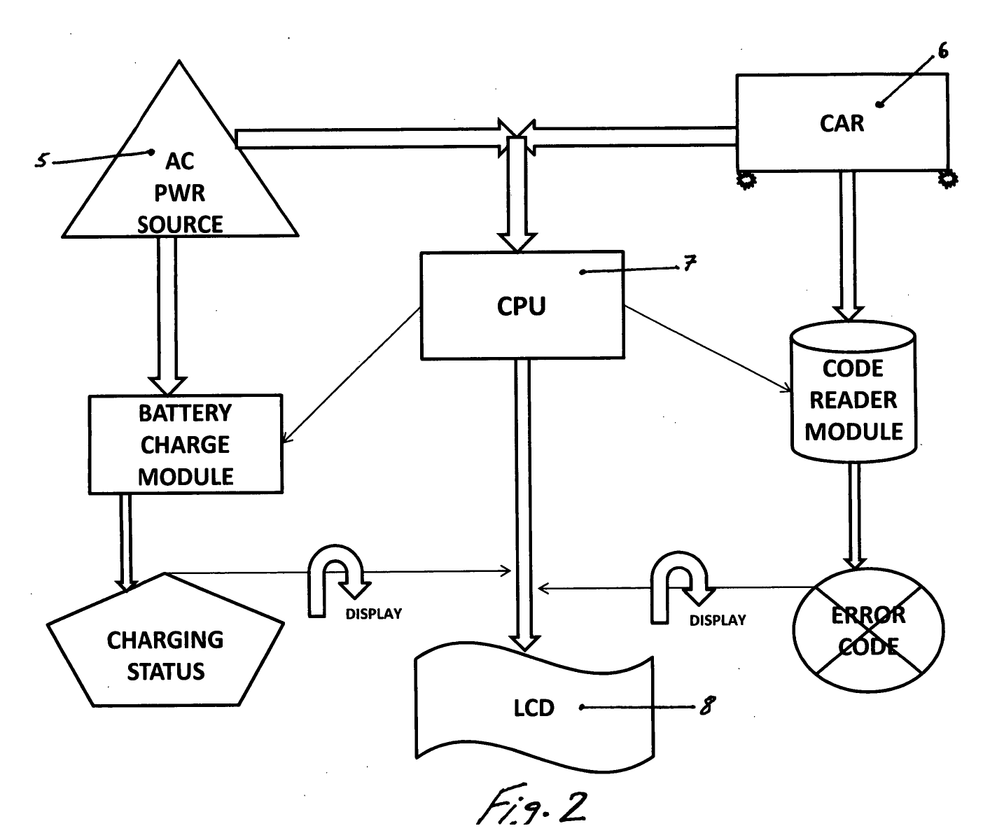

What is claimed is:

1. A portable battery charger apparatus for charging a vehicle battery and an integrated automobile fault code reader
comprising:
A battery charger that couples with the vehicle battery;
A voltage monitoring module that monitors an amount of voltage in the vehicle battery and outputs a voltage reading indicative of an amount of voltage in the vehicle battery;

2. A battery charger that reconditions the automobile battery;

3. A fault code monitoring system that displays vehicle fault codes and definitions on an LCD Screen of the apparatus;

4. The portable battery charger comprising a connection monitoring module that interfaces with automobile on board computer to diagnose fault codes;

5. A method for vehicle battery charging and reading fault codes using an apparatus, the method comprising:
Coupling the battery charger to the vehicle battery;
Monitoring voltage in the vehicle battery and determining amount of voltage in the vehicle battery;
Coupling the battery charger apparatus with a vehicle's on-board computer to obtain vehicle fault codes to diagnose vehicle problems.
